(19) United States
(12) Patent Application Publication
(10) Pub. No.: US 2002/0093209 A1
(43) Pub. Date: Jul. 18, 2002

(54) Anti-intrusion device for portal closure

(76) Inventors: James R. Gerchow, Sturgis, MI (US); Michael A. Hyska, Bronson, MI (US); William J. Schlabach, Bronson, MI (US)

Correspondence Address: FLYNN, THIEL, BOUTELL & TANIS, P.C., 2026 Rambling Road, Kalamazoo, MI, 49008-1699, US

(21) Appl. No.: 09/766,312

(22) Filed: Jan. 18, 2001

(51) Int. Cl. E05C 17/44; E05C 17/54

(52) U.S. Cl. 292/339; 292/338

(57) ABSTRACT

An anti-intrusion apparatus for a portal closure comprises first and second leg units having hingedly joined inner end portions and outer end portions respectively engagable with a closed movable closure at a portal and with fixed portal-adjacent structure. The apparatus folds for storage and has an unfolded use position in which the leg units are unfolded through an arc exceeding 180° to an over-center position. The first and second leg units are hinged at a knee unit wherein detent structure between the knee unit and at least one of the leg units defines a resiliently fixed relative position of the leg units. The first and second leg units are pivotally joined at the knee unit which in turn carries an alarm unit.

### FIELD OF THE INVENTION

This invention relates to an anti-intrusion device and devices for portal closures, such as doors and windows, intended to deny entry to an unwanted intruder.

### BACKGROUND OF THE INVENTION

Prior anti-intrusion devices have included a conventional top notched wooden board jammed between an interior door knob and the interior floor, to block inward opening of the door by an unwanted intruder. Another prior anti-intrusion device consisted of a conventional wooden board or broom handle placed in the track of a sliding patio door (or sliding window), between the door and door frame, along the interior face of the door, again to block opening of the door (or window) by an unwanted intruder.

Various anti-intrusion devices have been developed over the years to improve on the simple wooden boards and broom handle above mentioned. However, those of which I am aware have themselves suffered deficiencies and have not received wide acceptance and distribution. Deficiencies have included inability to adjust in length (at all or sufficiently) to accommodate a reasonable range of normal working length, inability to return to a non-use configuration small enough to allow easy transport in a conventional briefcase or duffel or suitcase, inability to adapt to different door and window configurations, difficulty of installation and removal from a point of use, inability to resist a high intrusion force (static or dynamic) applied by an attempting intruder, excessive weight, excessive cost, and the like.

The invention device is intended to improve on the mentioned prior devices.

### SUMMARY OF THE INVENTION

An anti-intrusion apparatus for a portal closure comprising first and second leg units having hingedly joined inner end portions and outer end portions respectively engageable with a closed movable closure at a portal and fixed portal-adjacent structure. In one embodiment, the apparatus folds for storage and has an unfolded use position in which the leg units are unfolded through an arc exceeding 180° to an over-center position. In another embodiment, the first and second leg units are hinged at a knee unit wherein detent structure between the knee unit and at least one of the leg units defines a resiliently fixed relative position of the leg units. In another embodiment, the first and second leg units are pivotally joined at a knee unit which in turn carries an arm unit.

### BRIEF DESCRIPTION OF THE DRAWINGS

FIG. 1 is an elevational view of a device embodying the invention in its folded transport/storage position.

FIG. 2 is an elevational view of the FIG. 1 device in its slightly flexed installation position, adjacent a swinging door to be secured.

FIG. 3 is a view similar to FIG. 2 with the device in its over-center, door locking position.

FIG. 4 is an enlarged, fragmentary, partially broken, central cross sectional view of the knee portion of the FIG. 1 device.

FIG. 5 is a view similar to FIG. 4 but with the device in its slightly flexed installation position.

FIG. 6 is a view similar to FIG. 5 with the device in its over-center, door locking position.

FIG. 7 is an enlarged side elevational view of the foot of FIG. 1.

FIG. 8 is a top view of the FIG. 7 foot.

FIG. 9 is a bottom view of the FIG. 7 foot.

FIG. 10 is an end view of the FIG. 7 foot taken from the heel thereof.

FIG. 11 is a view similar to FIG. 7 with the foot partially broken and with the lower tube and associated pivot pin shown in exploded relation thereto.

FIG. 12 is a side elevational view of a shoe engagable with the bottom of the FIG. 7 foot.

FIG. 13 is a bottom view of the FIG. 12 shoe.

FIG. 14 is an enlarged, fragmentary, partially broken elevational view of the lower leg unit tube of FIG. 2.

FIG. 14A is a view similar to FIG. 14 but rotated 90° about its length axis.

FIG. 15 is a partially broken side elevational view of the female hinge part of FIG. 5.

FIG. 16 is a partially broken view of the female hinge part taken from the left in FIG. 5.

FIG. 17 is an end view of the FIG. 15 hinge part taken from the pivot flange end thereof.

FIG. 18 is a partially broken side elevational view of the male hinge part of FIG. 5.

FIG. 19 is a partially broken view of the male hinge part taken from the left in FIG. 5.

FIG. 20 is an end view of the male hinge part taken from the left in FIG. 18.

FIG. 21 is an enlarged fragmentary partially broken elevational view of the outer tube of the upper leg unit of FIG. 2.

FIG. 21A is a view similar to FIG. 21 but rotated 90° about the longitudinal axis thereof.

FIG. 22 is an enlarged fragmentary partially broken elevational view of the upper leg unit of FIG. 2 showing the connection of the upper and lower tubes thereof.

FIG. 23 is a view of the inner tube similar to FIG. 22 but rotated 90° about the length axis thereof.

FIG. 24 is an enlarged, partially broken rear elevational view of the yoke of the upper end unit of FIG. 2.

FIG. 25 is a sectional view substantially taken on the line 25-25 of FIG. 24.

FIG. 26 is a partially broken side view of the FIG. 24 yoke displayed in exploded fashion with the plug, adapter, inner tube and fastener associated therewith in the FIG. 2 device.

FIG. 26A is an end view of the FIG. 27 adapter taken from the bottom end thereof in FIG. 27.

FIG. 27 is an enlarged central cross sectional fragment of FIG. 26 with the parts assembled together.

FIG. 28 is an end view of the traction face of the plug of FIG. 27.

FIG. 29 is an enlarged top view of the handle of the knee unit of FIG. 2.

FIG. 30 is a side elevational view of a modified version of the FIG. 29 handle.

FIG. 31 is an end view of the FIG. 29 handle, taken from the upper end in FIG. 2.

FIG. 32 is a central cross sectional view substantially taken on the line 32-32 of FIG. 29.

FIG. 33 is an end view of the FIG. 30 handle taken from the rightward end thereof.

FIG. 34 is a top view of the FIG. 30 handle.

FIG. 35 is an enlarged pictorial view of the handle of FIGS. 1-3.

FIG. 36 is a fragmentary view showing the FIGS. 1-3 device, with the knob engaging yoke removed, securing a sliding closure.

FIG. 37 is a view generally similar to FIG. 36 but with the foot differently positioned.

FIG. 38 is an enlarged fragment of FIG. 37.

FIG. 39 is a view similar to FIG. 3 but showing the inventive device securing a sliding portal by engaging a handle thereof.

FIG. 40 is a schematic diagram of a simple alarm circuit usable in the FIGS. 1-3 device.

FIG. 41 is a flow chart illustrating a preferred form of alarm unit for the FIGS. 1-3 device.

### DETAILED DISCUSSION

In the following discussion, it will be understood that the words up, down, right, left, top, bottom, and derivatives thereof, refer to positions in the accompanying drawings and are not limiting as to possible orientations of the inventive structure and actual use.

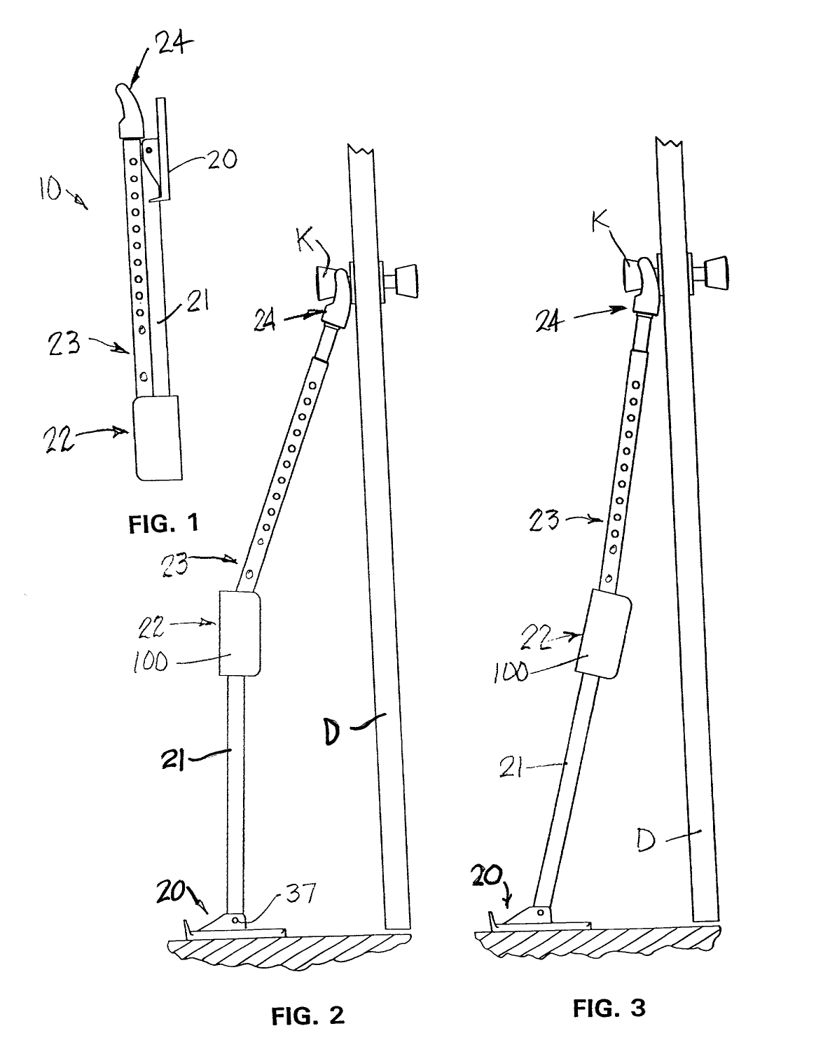

A preferred embodiment of the invention provides an anti-intrusion device 10 (FIGS. 1-3) which, by way of analogy to a human leg, has connected in sequence a foot 20, lower leg unit 21, knee unit 22, an upper leg unit 23 and an upper end unit 24.

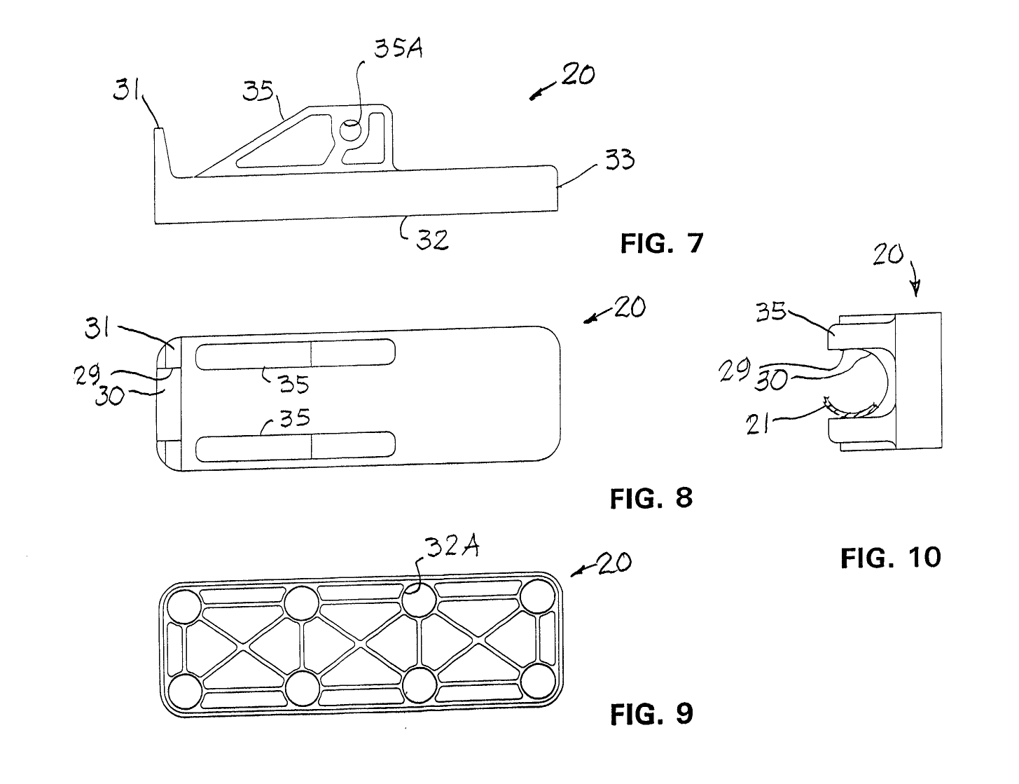

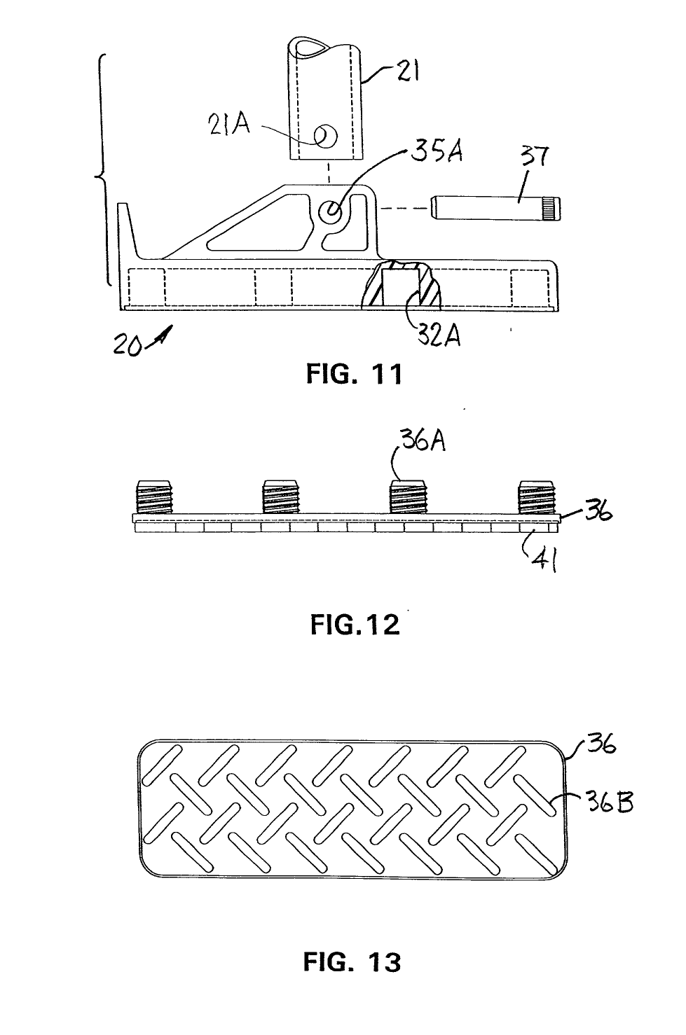

The foot 20 (FIGS. 7-10) has turned up, laterally spaced toes 31 spaced by a notch 30, an underlying sole 32, a heel portion 33 and an upstanding, laterally spaced pair of ankle bosses 35 having laterally aligned pivot holes 35A. The notch 30 is semicircular and extends through slightly more than 180° to form opposed detent protrusions 29 at the free ends of the toes 31. A shoe 36 (FIGS. 11-18) has upstanding bosses 36A fixed in recesses 32A (FIG. 9) in the sole 32 of the foot 20 to fix the shoe 40 to the underside of the foot 20. The shoe 36 preferably is of resilient, rubber-like material and has an anti-skid texture 36B (FIGS. 12 and 13) on its underside.

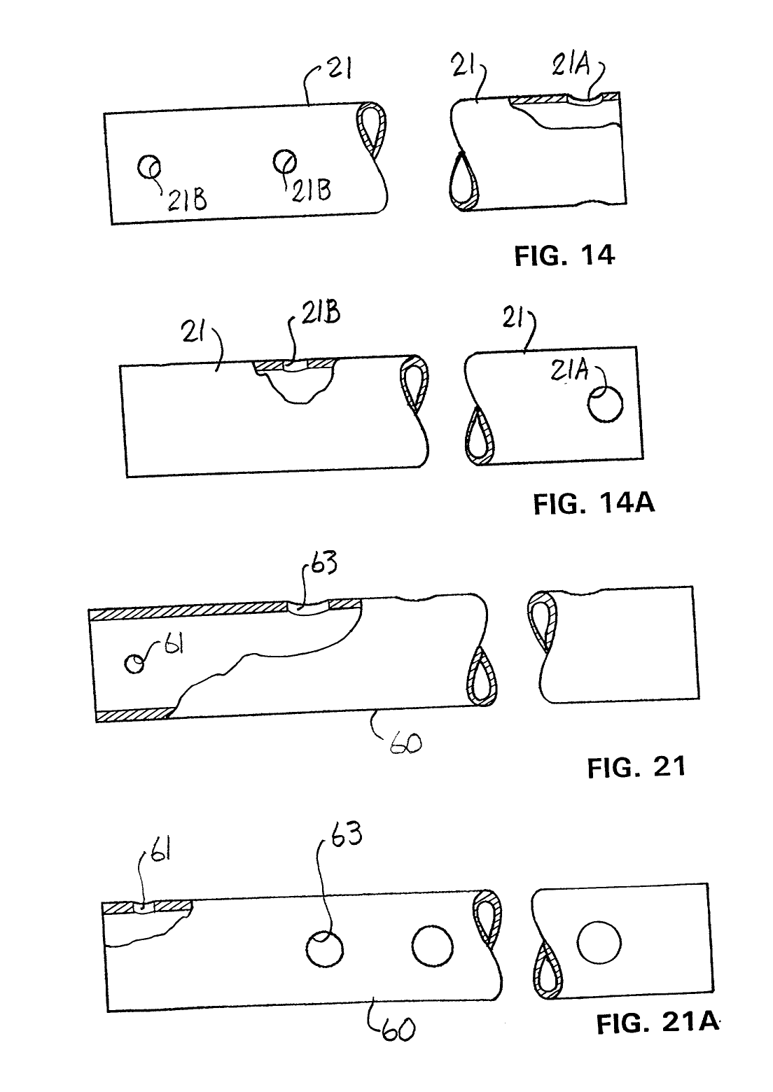

The lower leg unit 21 (FIGS. 14 and 14A) is defined by an elongate rigid tube. This lower leg tube 21 has diametrically opposed pivot holes 21A adjacent its lower (rightward in FIG. 14) and axially spaced attachment holes 21B adjacent its upper end. The lower leg tube 21 is pivotably fixed to the ankle bosses 35 of the foot 20 by an axially fixed pivot pin 37 (FIG. 2) extending through the holes 21A and 35A respectively therein.

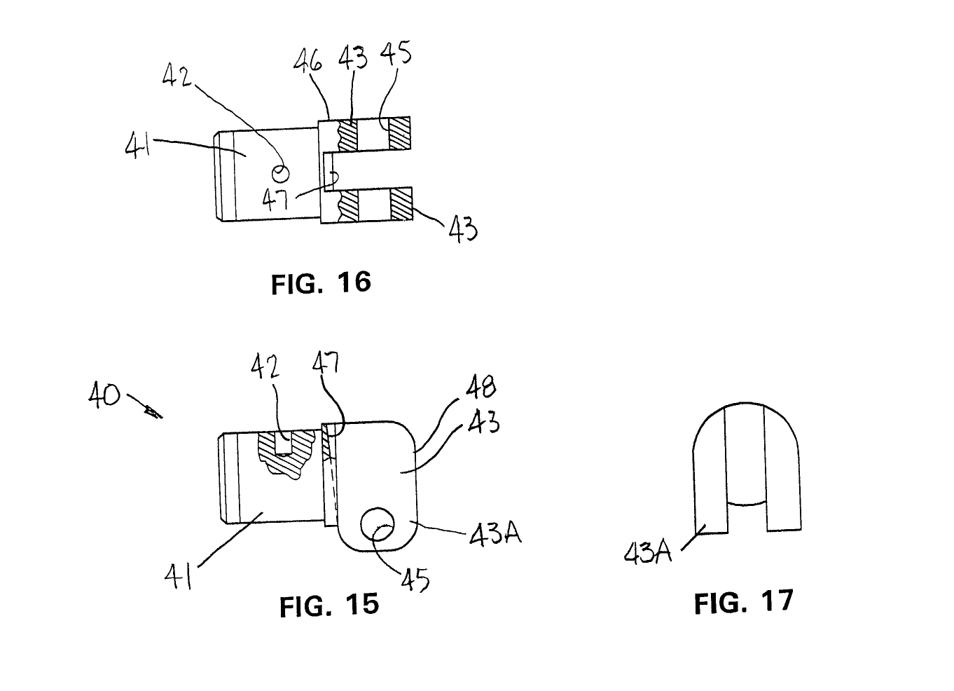

The knee unit 22 includes a female hinge part 40 (FIGS. 15-17) having a generally cylindrical boss 41 sized to fit snugly in the upper end of the lower leg tube 21, a pair of laterally spaced flanges 43 extending from and straddling the axis of the boss 41, and a disklike portion 46, of diameter greater than the boss 41 which is interposed between and connects the flanges 43 with the inboard end of the boss 41. The flanges 43 have ear portions 43A which extend radially outward beyond the boss 41 and disk 46 and carry aligned hinge pin holes 43A spaced eccentrically from the longitudinal axis of the boss 41. The disk-like portion 46, between the flanges 43, is grooved to form a ramp 47 which slopes away from the radial plane in a direction away from the hinge pin holes 45 at a slight angle, in one embodiment between half a degree and one degree (preferably 0° 45′) and in another less preferred embodiment between 2 to 3 degrees. The groove defining the ramp 47 is deepest at its end furthest from the hinge pin holes 45. The boss 41 has a radially opening blind hole 42.

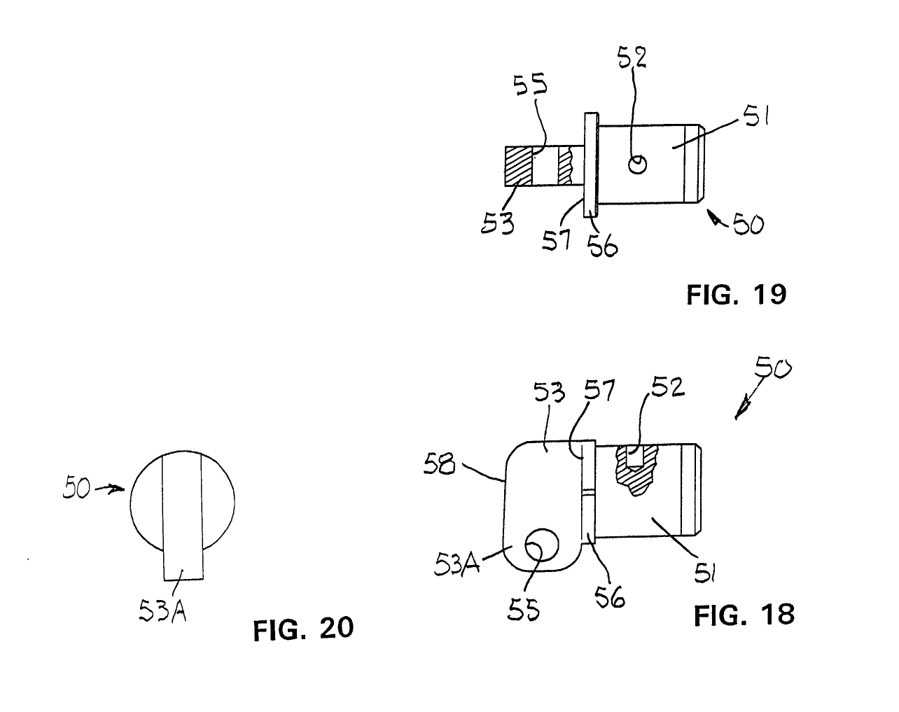

The knee unit 22 further includes a male hinge part 50 (FIGS. 18-20) comprising, in sequence, a generally cylindrical boss 51, a disk-like portion 56 at the inboard end of the boss 51 and a substantially diametrically located male flange 53, the disk-like portion 56 fixedly separating the boss 51 and male flange 53 and being sandwiched therebetween. The boss 51 has a radially opening blind hole 52. The flange 53 has an axially outward facing edge 58 and an ear portion 53A extending radially beyond the peripheral edge of the disk-like portion 56 in a radial direction opposite of the blind hole 52. A hinge hole 55 extends through the ear 53A. In the embodiment shown, the disk-like portion 56 has a radial face 57, from which the flange 53 extends, which face 57 is a planar, radial face.

The upper leg unit 23 comprises an elongate outer tube 60 (FIGS. 21 and 21A) which at its lower end (left end in FIG. 21) has an attachment hole 61 through the tube peripheral wall and an axially spaced series of length adjustment holes 63 extending from the upper (right in FIG. 21) and of the outer tube 60. The axis of the hole 61 is here displaced about 90° along the circumference of the tube 60 from the axes of the holes 63.

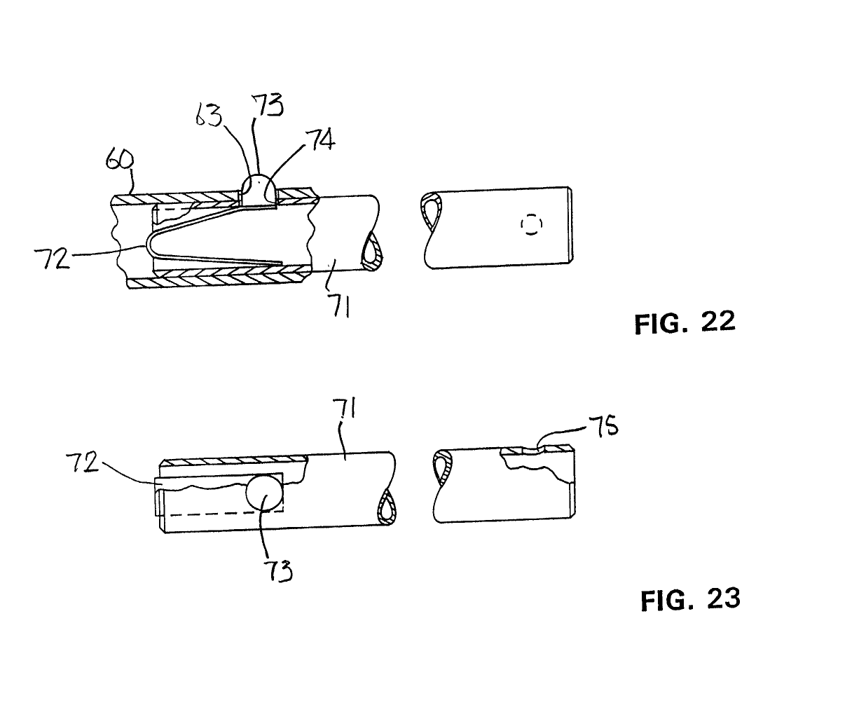

The upper leg unit 23 further includes an upper, inner, sliding tube 70 (FIGS. 22 and 23) having an attachment hole 75 through the upper (rightward in FIGS. 22 and 23) end portion thereof. The lower end portion 71 of the inner tube 70 has a detent hole 74 through the peripheral wall thereof. In the embodiment shown, the detent hole 74 is preferably displaced about 90° along the tube circumference from the attachment hole 75. A resilient detent unit comprises a general U-shaped leaf spring 72 having ends extending into the bottom end of the tube 70 and pressing radially outward against the inner peripheral wall thereof at diametrially opposed locations. A detent button 73 is fixed to one end of the leaf spring 72 and is resiliently urged by the leaf spring 72 through the detent hole 74, so as to protrude beyond the outer periphery of the tube 70.

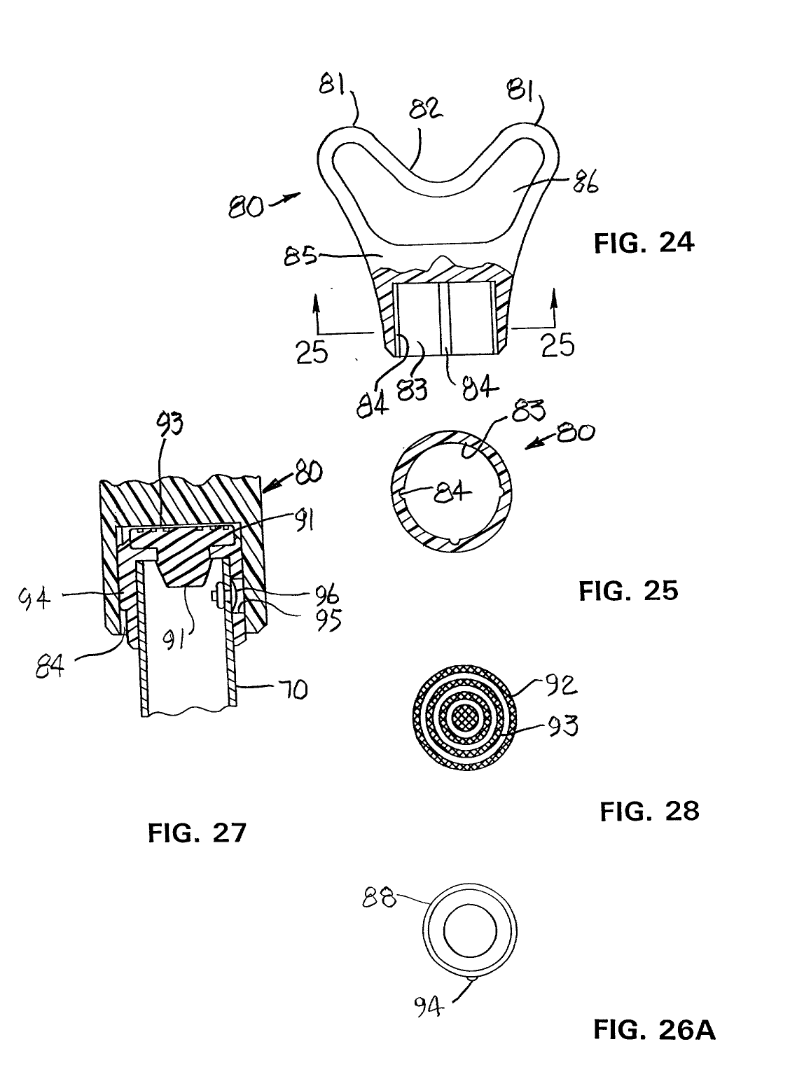

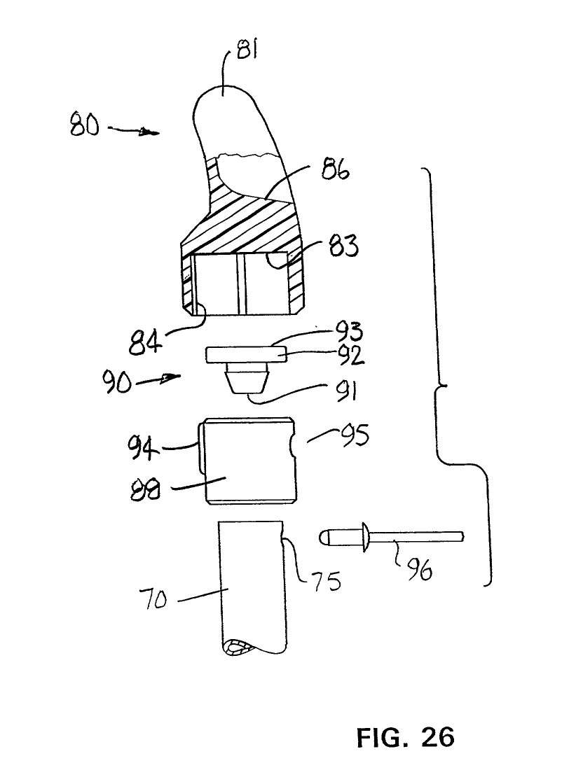

The upper end unit 24 (FIGS. 24-28) comprises a generally Y-shaped yoke 80 (FIGS. 24-26) and its bottom portion has a downwardly opening generally cylindrical recess 83. Grooves 84 extend the length of the peripheral wall of the recess 83, are preferably spaced circumferentially at 90° intervals and are located at least at diametrically opposite sides of the recess 83 and on the back (leftward in FIG. 26 peripheral wall portion of the recess 83). As seen in profile in FIG. 26, the upper portion of the yoke 80 is generally V-shaped as seen from the front or rear (FIG. 24) and refines two upwardly divergent arms 81 spaced by an upward opening generally V-shaped notch 82. As seen in FIG. 26, from the side, the yoke midportion 85 is offset rearwardly with respect to the central axis of the recess 83 and the arms 81 angle upwardly and somewhat forwardly therefrom. The yoke 80 is preferably a molded part and material is saved by providing a valley 86 in the rear face thereof extending upward from the midportion 85.

The upper end unit 24 further includes a generally cup-shaped adapter 88 (FIGS. 26, 26A and 27). The upper end unit 24 further includes a plug 90 having a tapered, reduced diameter, undercut, inner end portion 91 snap fitted through a central opening in the end wall of the generally cup-shaped adapter 88. The plug 90 has an outer portion in the form of a radially extending traction flange 92 coaxially fixed to and extending forward from the undercut inner end portion 91. The traction flange 92 protrudes axially (normally upwardly) beyond the adapter 85 and has a textured (here grooved) traction face 93 facing axially outwardly and away from the adapter 85. Preferably, to help maintain the plug 90 coaxial with the adapter 88, the inner portion of the flange 92 may be recessed in the end wall of the generally cup-shaped adapter 88. The adapter 88 has an axially extending rib 94 on its outer periphery. The peripheral wall of the adapter 88, preferably at a location diametrically opposite to the rib 94, has a outwardly recessed radial through hole 95.

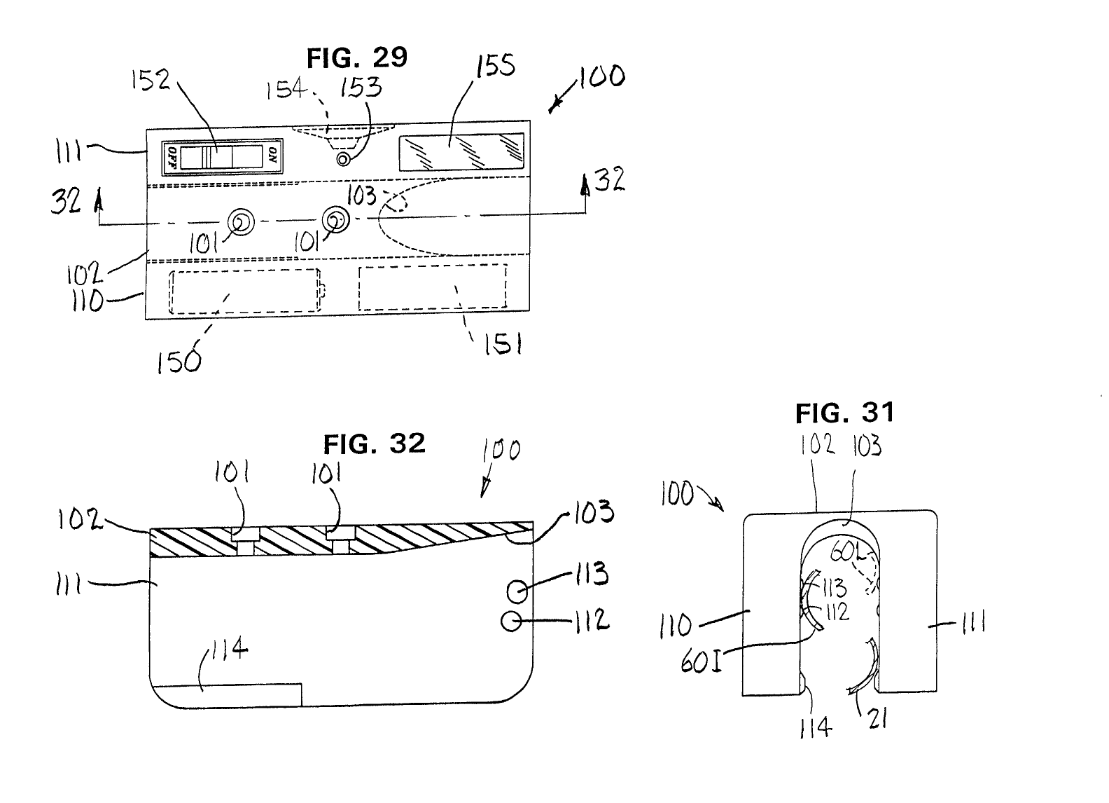

The knee unit 22 further includes a generally channel shape (U cross section) handle, or housing, 100 (FIGS. 29, 31 and 32) having a longitudinally extending bight wall 102 fixedly connecting the tops (in FIG. 31) of substantially parallel, laterally spaced, relatively thick, side walls 110 and 111 which extend from opposite side edge portions of the bight wall 102. The interior surface of the normally upper (rightward in FIG. 32) part of the bight portion 102 is relieved to form a ramp 103, here angled at a range of 4 to 6 degrees, preferably about 5°, to the length axis of the handle 100. As seen in FIG. 31, the interior surface of the bight wall 102 and of the ramp 103 therein are preferably of generally circular cross section, conforming snugly but slidably to the periphery of the tubes 21 and 60.

The opposed interior faces of the side walls 110 and 111 have opposed pairs of detent protrusions 112 and 113, located generally one above the other adjacent the normally, rightward in FIG. 32, end of the handle 100. The detents 112 and 113 are below (in FIG. 32) the free end portion of the ramp 103. The opposed interior faces of the side walls 110 and 111 also have an opposed pair of closure detents 114 extending along the free edge (bottom edge in FIGS. 32 and 33) of the legs 110 and 111. The closure detents 114 extend from the normally bottom (left in FIG. 32) end of the handle 100 somewhat less than half way to the other end of the handle 100. Outwardly recessed through holes 101 are spaced along the central axis of the bight wall 102, one being substantially centered between the ends of the bight wall 102 and the other being spaced about half way to the leftward (in FIG. 32) end of the bight wall 102, in the region above the closure detents 114.

Of the structural elements above discussed, the tubes 21, 60 and 70 are of a lightweight metal, preferably aluminum, the female and male hinge parts 40 and 50 are preferably of a tough metal material such as aluminum or a suitable or suitably finished steel, the spring 72 is preferably of spring steel and the button 73 is preferably of a suitable non-corroding metal e.g. aluminum. The foot 20, yoke 80, adapter 88, and handle 100 are preferably molded of a suitable rigid plastics material, variously either unfilled, or filled with reinforcing elements, such as conventional glass fibers.

To the extent above described, the apparatus may be assembled as follows.

As above indicated, the foot 20 is pivotably secured to the bottom of the lower leg tube 21 by fixedly locating the pin 37 through the pivot holes 21A (FIG. 14) of the lower leg tube 21 and the pivot holes 35A (FIG. 7) of the foot 20.

The cup shaped adapter 88 is telescoped over the upper end of the inner sliding tube 70 with their respective holes 95 and 75 aligned. A suitable fastener, preferably a pop rivet 96 (FIGS. 26 and 27), is received in the holes 95 and 75, and fixes the adapter 88 on the upper end of the inner tube 70.

The plug 90 is snap fitted into the hole in the end wall of the adapter 88, as seen in FIG. 27.

The yoke is then frictionally telescoped over the adapter 88, with a selected one of its grooves 84 receiving the rib 94 of the adapter generally as indicated at FIG. 27. The head of the rivet 96 is recessed so as not to interfere with seating of the adapter 88 and plug 90 within the recess 83 of the yoke 80.

As seen in FIG. 22, the lower end of the inner sliding tube 70 is inserted in the upper end of the outer tube 60 of the upper leg unit 23. The detent button 73 is depressed so as to slide along the interior periphery of the outer tube 60, until the spring 72 is allowed to resiliently urge the detent button 73 outward through a desired one of the length adjustment holes 63 in the outer tube 60, thereby fixedly but releasably establishing the effective length of the upper leg unit 23.

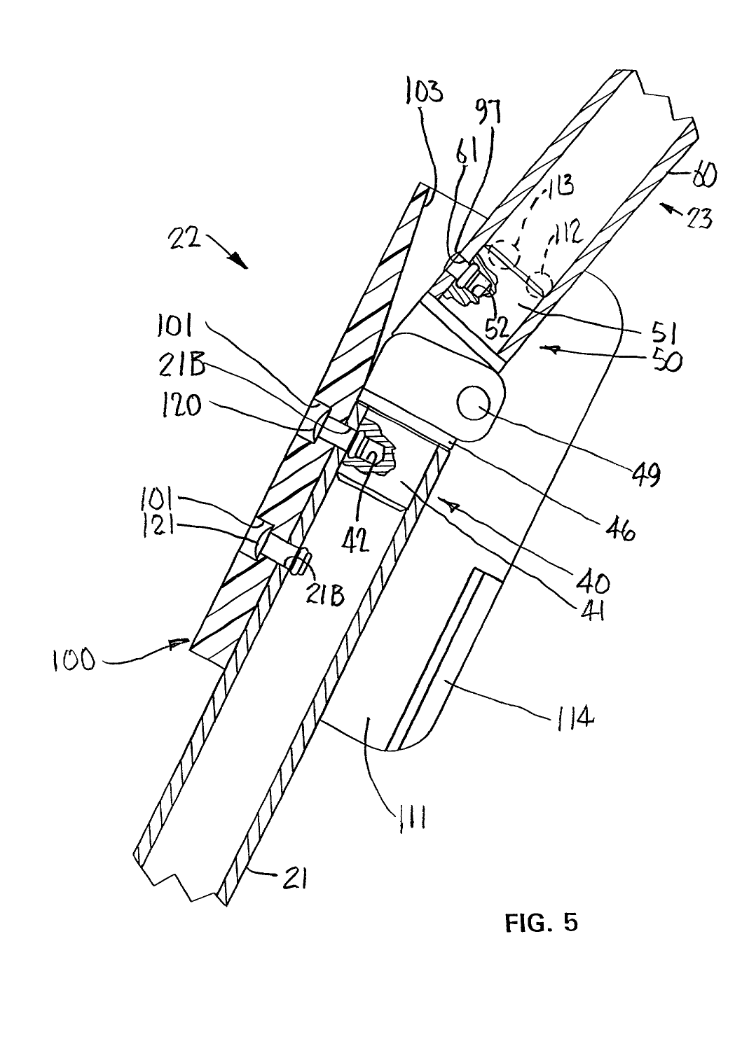

The boss 51 of the female hinge part 50 is snugly telescoped in the bottom end of the outer tube 60 of the upper leg unit 23 with their respective holes 52 and 61 aligned. The lower end of the outer tube 60 is then fixed to the boss 51 of the male hinge part 50 by a suitable fastener, preferably a pop rivet 97 (FIG. 5), recessed in and extending through the upper tube attachment hole 61 and expanded tightly in the blind hole 52 in the boss 51.

The hinge parts 40 and 50 are pivotally coupled by inserting the flange 53 of the male hinge part between the flanges 43 of the female hinge part, with their respective ears 53A and 43A aligned and with their hinge holes 45 and 55 coaxially aligned. An elongate cylindrical hinge pin 49 (FIG. 5), of conventional type, is inserted through the hinge holes 45 and 55 in a snug but rotatable manner, to hingedly connect the hinge parts 40 and 50, and thus form a hinge 40, 50. The boss 41 of the female hinge part 40 is snugly telescoped into the upper end of the lower leg tube 21 with the boss hole 42 aligned with the outboardmost attachment hole 21B in the tube 21.

The U-cross section, generally saddle shaped handle 100 is slid rearward (rightward in FIG. 5) over the hinge 40, 50, such that the inside face of the bight wall 102 abuts the front (leftward in FIG. 5) faces of the hinge 40, 50 and adjacent upper portion of the lower tube 21. The side walls 110 (not shown in FIG. 5) and 111 snugly but slidably sandwich therebetween the hinge parts 40 and 50, hinge pin 49 and the adjacent end portions of tubes 21 and 60 and indeed extend somewhat rearwardly (rightwardly in FIG. 5) therebeyond. The ramp 103 extends upward along the upper hinge part 50 and lower portion of tube 60 substantially from the disk like portion 46 of the lower hinge part 40. Thus, the ramp 103 opposes the pop rivet 97.

Fasteners 120 and 121, preferably pop rivets, fix the handle to the lower hinge part 40 and lower tube 21. More particularly, the pop rivet 120 is recessed in the upper (in FIG. 5) one of the recessed holes 101 in the handle 100 and extends through the upper one of the holes 21B in the lower tube 21 and is expanded in the blind hole 42 in the boss 41 of the lower hinge part 40 to fixedly grip the boss 41, presses handle bight wall 102 tightly against the peripheral wall of the tube 21, and to sandwich the latter snugly between the handle bight wall 102 and lower hinge part boss 41.

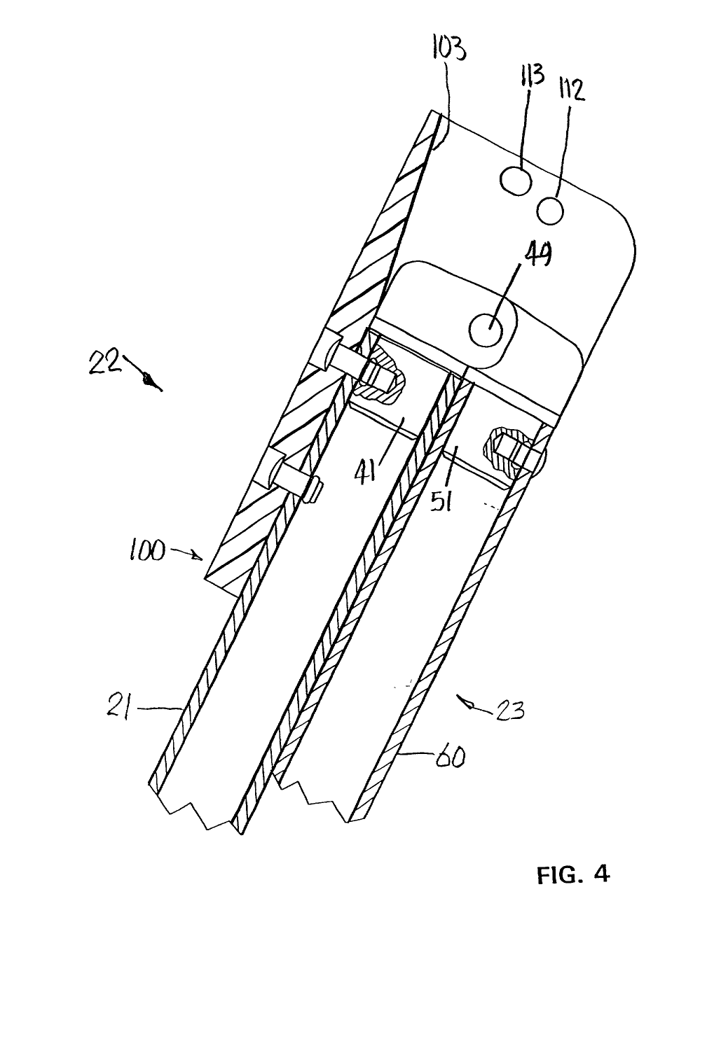

The second pop rivet 121, is inserted through the recessed hole 101 in the handle bight wall 102 and the second hole 21B of the lower tube 21 and is expanded to press the tube 21 peripheral wall tightly against the interior face of the handle bight wall 102. In this way the handle 100 is fixed to the upper portion of the lower tube 21 and to the lower hinge part 40, such that the upper hinge part 50 and tube 60 are pivotable within the saddle shaped handle 100 between the positions shown in FIGS. 4-6.

Although rivets have proved to be an inexpensive, quickly and easily installed, and yet positive type of fastener, fasteners of other types may be used as desired, such as screws.

In a preferred embodiment, the device 10 includes an alarm unit 149, of any convenient type responsive to mechanical shock to the device 10 generated by an intruder attempting to open a closure (door or window) guarded by the device 10. The alarm unit 149 is conveniently located in the knee unit housing 100, particularly and primarily in the legs 110 and 111 thereof.

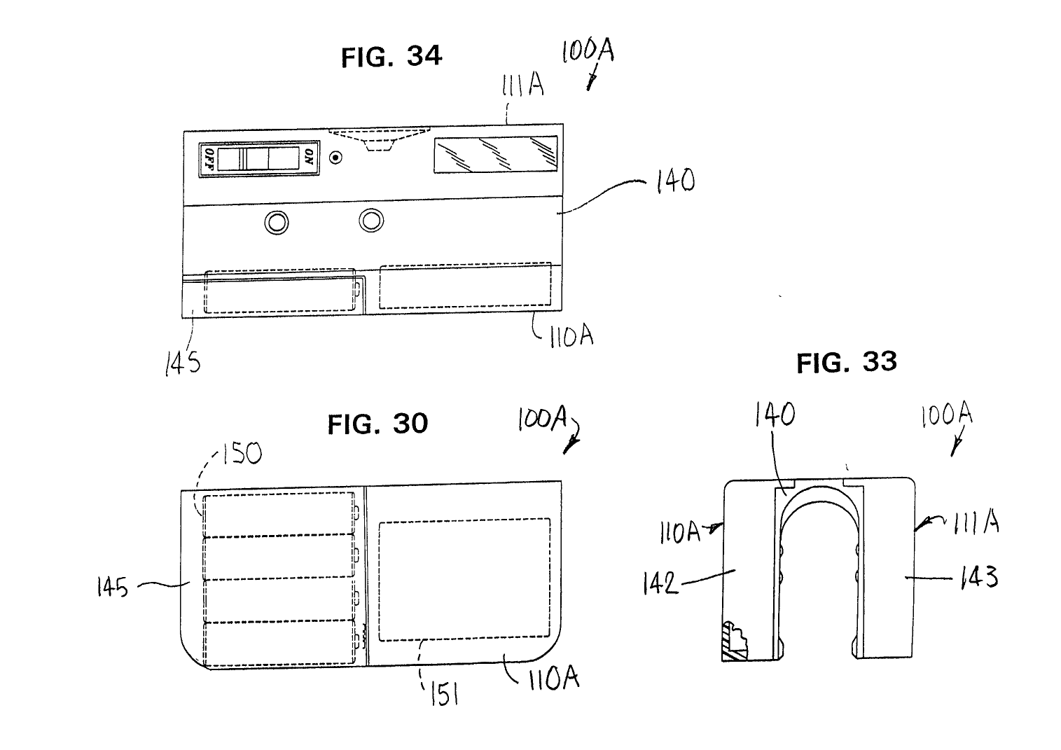

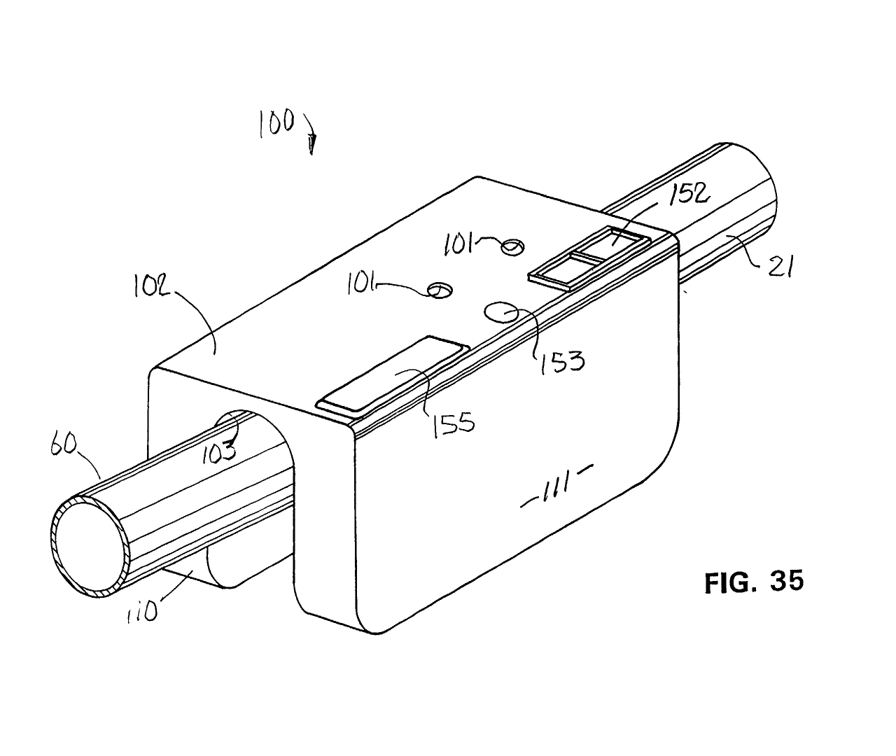

From one embodiment, the alarm unit included an on/off (manual) switch 152, a circuit “on” indicator (e.g. an LED) 153, an audible alarm device (e.g. buzzer, oscillator driven loud speaker, etc.) 154, a light emitting alarm device (e.g. a conventional incandescent bulb behind a light transmitting shield) 155, an electrical source (typically batteries, conveniently 4 AA alkaline cells in series) 150 and a circuit (e.g. circuit board schematically indicated at 151 in FIG. 30) incorporating a conventional mechanical shock responsive switch schematically indicated at 156, and operatively interconnecting same with the above mentioned components 150 and 152-155.

The circuit 151 may be of various conventional types. At minimum, the circuit 151 is capable of being armed by the user manually turning on the on/off switch 152 whereafter any mechanical shock, or jiggling, of the device 10 (as by an intruder attempting to enter the protected room) actuates the alarm devices 154 and 155.

The alarm devices 154 and 155 may, in the simplest embodiment, remain energized until user manually turns off the on/off switch 152. This operation can be provided, for example, by the immediately below described circuitry somewhat schematically indicated in FIG. 40.

In FIG. 40, a circuit path comprising the manual on/off switch 152 and battery pack 150 as paralleled by:

(1) the circuit “on” indicator 153,

(2) the shock responsive switch 156 in series with the energizable portion 160 of a latch inch device 163, and

(3) a normally open contact 164 of the latch 163 in series with parallel paths containing the alarm devices 155 and 154, respectively.

To the extent above described, closure of the manual on/off switch 152 by the user results in turning on of the indicator 153. Thereafter, a mechanical shock of desired minimum magnitude, applied to the device 10, results in momentary actuation of the shock responsive switch 156, energization of the latch energizable portion 160, closure of the latch contact 164, and energization of the alarm devices 155 and 154. In the FIG. 40 circuit, the latch energizable portion 160 is additionally connected at 165 in parallel with the alarm devices 155 and 154 so as to hold the latch contact 164 closed, despite reopening of the mechanical shock responsive switch 156. Thus, to the extent above described, the FIG. 40 circuit would maintain the alarm devices 155 and 154 energized until the user opens the manual on/off switch 152, which deenergizes all of the circuit paths (1), (2) and (3) above described.

If desired, the circuit 151 may be modified to automatically turn off the actuated alarm devices 155 and 154 after a predetermined time interval (e.g. 20 seconds) after the last actuation of the shock responsive switch 156, and until the mechanical shock responsive switch 156 is again actuated by another sufficient mechanical shock applied to the device 10, as by an attempting intruder. To this end, a conventional timer 170 is in FIG. 40 connected in parallel with the alarm devices 154 and 155 such that energization of its “on timer” input 171, simultaneously with energization of the alarm devices 154 and 155, starts it timing the desired alarm “on” time interval ΔT. At the end of the timed interval ΔT the timer acts through a line 172 to energize the actuable portion 176 of a further latch device 175 to open its normally closed contact 177. Contact 177 is in FIG. 40 connected in series with the first latch contact 164 and the parallel alarm devices 155 and 154 in timer 170. Thus, opening the normally closed contact 177 deenergizes the latch 163, returns its contact 164 to its normally open condition, deenergizes the alarm devices 154 and 155 and deenergizes (resets) the timer 170, which in turn deenergizes the second latch 175 and returns its contact 177 to its normal closed condition. Thus, the circuit is now restored to await another possible mechanical shock sufficient to actuate the shock responsive switch 156 and cause another alarm “on” interval.

For convenience in schematic representation of the alarm unit 149 in FIG. 40, the latch devices 163 and 175 are schematically indicated as conventional electromechanical relays. However, for compactness and economy, it is preferred that conventional electronic latch devices be provided at 163 and 175.

The FIG. 40 circuit is disclosed merely by way of example, and use of alternative conventional circuitry of various kinds, capable of generally similar alarm operation, is contemplated. For example, the alarm unit 149 may include any desired hard wired analog or digital logic circuitry and/or programmed or programmable computer circuitry capable of providing the desired operation. FIG. 41 discloses a flow chart for a suitable alarm unit 149B wherein the user turns the manual switch on to determine if the battery or other circuit components are in proper condition. If not, further operation cannot take place. On the other hand, if such condition is satisfactory, the circuit “on” indicator is actuated and the circuit is enabled. Thereafter sensing of mechanical shock initiates timing of an alarm interval ΔT, during which time alarm devices, such as alarm devices 154 and 155, are held on. Upon timing out of the alarm interval ΔT, the alarm devices shut off and the timer is reset to await the onset of another mechanical shock (if any) which will cause another alarm cycle.

It is convenient to locate the alarm unit 149 within the confines of the handle 100, and particularly within the legs 110 and 111 thereof, for example as generally indicated in FIGS. 29, 30 and 34. In the example shown, the batteries 150 and circuit 151, including the shock responsive switch 156, are housed in the side wall 110 and the audible alarm device 154 is housed in the other housing side wall 111. The manual on/off switch 152, circuit on indicator (e.g. LED) 153 and light emitting alarm device 155 are recessed atop the side wall 111.

The components 150-156 of the alarm unit 149 may be carried by the handle 100 in one of several ways. For example, in the FIGS. 29, 31 and 32 embodiment, the handle 110 is a one-piece molded plastic piece and the components 150-156 (and their connecting wiring) of the alarm unit 149 are molded in place therein.

Preferably however, and to allow access to the alarm unit components, particularly the batteries for replacement, a preferred handle 100A (FIGS. 30, 33 and 34) is constructed in three parts. More particularly, the handle 100A comprises a narrow, channel shaped backbone 140 (FIG. 33) of a tough, durable plastics material, e.g. a suitable rigid resin reinforced with glass fibers. The handle side walls 110A and 111A are completed by mirror imaged hollow shells 142 and 143 respectively fixed by any convenient means not shown (e.g. screws) to, and laterally flanking the sides of the backbone 140, and are provided with any desired conventional structure (not shown) to hold in place therein the corresponding ones of the components 150-156. If desired, the shell 142 may include a cover 145 (FIG. 34) removably fixed to the shell 142 and covering the batteries 150, to allow battery replacement as needed.

### Operation

The inventive device 10 telescopes and folds into a compact storage condition shown in FIGS. 1 and 4. The device 10 in storage configuration is short enough to fit in most duffles, briefcases, and suitcases and can easily be taken on a trip to positively block entry to the traveler's hotel room while he/she sleeps. Its vibration mechanical shock sensor switch trigger its self-contained light and sound alarms to warn its user of an attempted intrusion and to scare away the attempting intruder.

The device 10 is maintained in its FIG. 1 compact folded condition as follows. The shoe 20 in its FIG. 1 storage position resiliently grips the lower tube 21 between the detent protrusions 29 (FIG. 10) so as to resiliently retain the lower tube 29 within the notch 30 of the shoe 20 during storage. The detent protrusions 114 (FIG. 31) align the free edges of the handle legs 110 and 111 resiliently releasably retain the lower tube 21 between the legs 110 and 111.

To use the device 10, one handle of the user conveniently grips the handle 100 (palm adjacent the bight wall 102 and fingers and thumb extending along the opposite side walls). The other hand of the user then forcibly pivots the foot 20 out of its FIG. 1 stored, detent held position to allow to pivot freely on the lower end of the lower tube 21. The other hand of the user then partially unfolds the device 10 at the knee unit 22, by pivoting the upper leg unit 23 away from the lower leg 21 by overcoming the resiliently or releasable grip of the closure detent protrusions 114 (FIGS. 5 and 31) on the lower leg 21.

While still holding the housing 100 the knee unit 22 in one hand, the other hand of the user partially unfolds the device 10 by pivoting the upper leg unit 23 away from the lower leg 21 from its FIGS. 1 and 4 position toward its FIGS. 2 and 5 position. The tube 60 of the upper leg unit 23 encounters the detent protrusions 112 (FIGS. 5 and 31) and is forced by the user pivotally and resiliently therepast to engage the further detent protrusions 113. The user normally will temporarily leave the device 10 in this slightly flexed, resiliently maintained, installation detent position, with each side of the tube 60 of the upper leg unit 23 resiliently trapped, against unintended hinging motion, between its corresponding detent projection 112 and detent projection 113, as schematically indicated at 601 in FIG. 31. In this slightly flexed, resiliently maintained, installation position of FIGS. 2 and 5, the device 10 can be moved about by the user without fear of its unexpectedly folding. Next the user then places the foot 20 on the interior floor of the room to be protected, e.g., 6-10 inches from the interior face of a closure (namely the inswinging door D). The user then telescoingly extends the upper leg unit 23 until the upper end member 24 (more particularly the Y-shaped yoke 80) snugly engages the underside of the shaft of the door knob K.

Insert 08-1

To telescopingly extend the upper leg unit, the user pushes the push button 73 (FIG. 22) radially inward through the corresponding hole 63 in the outer tube 60 and slides the inner tube 71 upwardly therein to spring outward through another one of the holes 63 in the outer tube 60 when the upper leg unit 23 is sufficiently extended. Thereafter, the user firmly pushes the knee unit 22 toward the door D. This causes the outer tube 60 of the upper leg unit 23 to pivot resiliently past the detent protrusions 113.

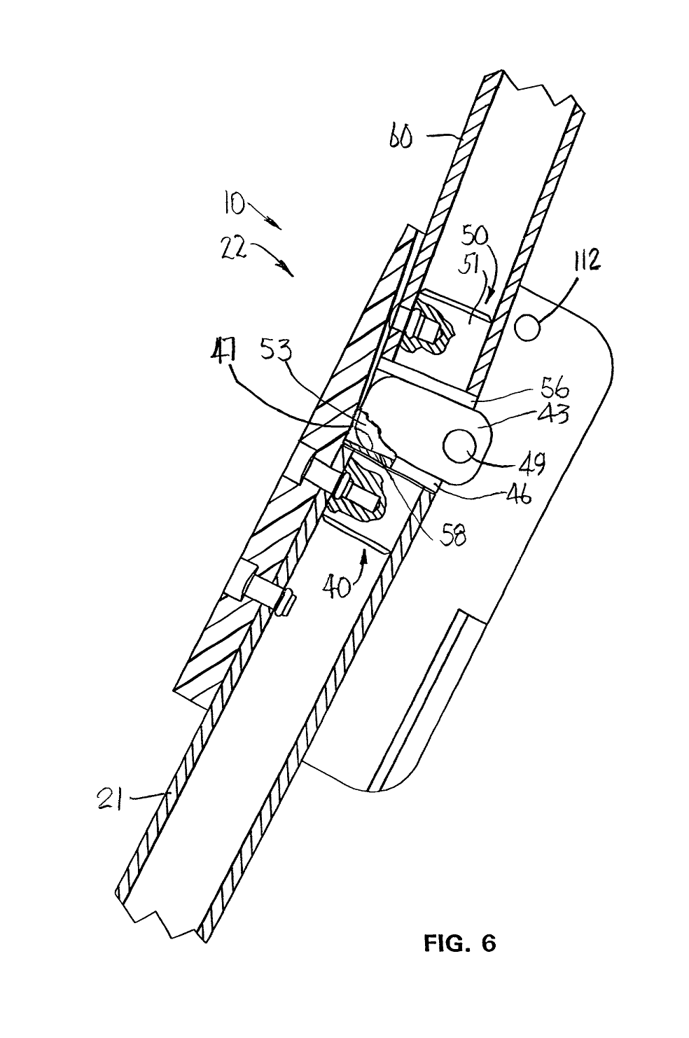

Thereafter, the user pushes the knee unit 22 toward the door D. This pivots the outer tube 60 (FIG. 5) past the detent projections 113 toward the ramp 103, until the end edge 58 of the male flange 53 on the male hinge part 50 pivots into abutment with the ramp 47 of the female hinge part 40, as generally indicated in FIG. 6. This positively stops pivoting of the tube 60 with respect to the knee unit 22 and lower tube 21 in the over-center, door locking position of FIGS. 3 and 6.

The outer tube 60 is resiliently retained against accidental movement out of this position by the opposed detent protrusions 113, as generally indicated at 60L in FIG. 31. This resilient holding of the device 10 in its over-center position resiliently resist accidental folding of the device 10 if handled, as for purposes of inspection, at some location away from a door or window to be secured.

However, the detent protrusions 113 are not needed to maintain device 10 in its over-center position with the foot 20 and upper end member 24 firmly engaging the floor and knob K, respectively. More particularly, with the device 10 in its intermediate flexed FIG. 2 position, the above described displacement of the knee unit 22 toward the door D, into its over-center FIG. 3 position, also forcibly presses the upper end unit 24 against the shaft of the knob K and the foot 20 against the floor. In reaction, the knob K and foot 20 correspondingly forcibly urge the upper and lower leg units 23 and 21 longitudinally toward each other, and thus forcibly press the male hinge part edge 58 against the female hinge part ramp 47, and thereby positively hold the device in its FIGS. 3 and 6 over-center, door locking position.

To pivot out of that over-center position, the effective length of the device 10 must increase. However, each increase is resisted by the door knob K and floor, which would increase the longitudinal compressive force on the device 10 and thus increases the tendency of the device 10 to stay in its FIG. 3 over-center position. As a result, the device 10 is positively forced to stay in its FIG. 3 over-center door locking position. Thus, the device 10 is entirely stable in its FIG. 3 door locking position.

Thus, an intruder, attempting to open the door 10 by pushing the door 10 ever harder against the device 10, further to an increased longitudinal compression force on the device 10, and so forces the device 10 ever more positively to maintain its FIGS. 3 and 6 over-center door locking position.

With the device 10 thus positioned in its FIGS. 3 and 6, over-center, door locking position, the user can turn on manual switch 152 an thereby arm the alarm unit 149. An intruder thereafter attempting to push open the door D against the device 10 will mechanically shock, or jiggle the door, device 10 and alarm unit 149 and thus actuate the alarms 152 and light 155, to warn the user of the attempted intrusion, the audible alarm also serving to warn away the attempting intruder and summon help.

To open the door, the user shuts off the manual switch 152 and then releases the device 10 by pulling the knee unit 22 away from the door (leftward in FIG. 3) to or beyond its FIGS. 2 and 5 installation detent position. This removes the yoke 24 from the door knob K, eliminates the compressive force on the device 10, and releases the foot 20 from the floor. Hence, the device 10 can be moved entirely away from the door and folded to its FIGS. 1 and 4 storage/transport position. The user can then open the door and leave the room.

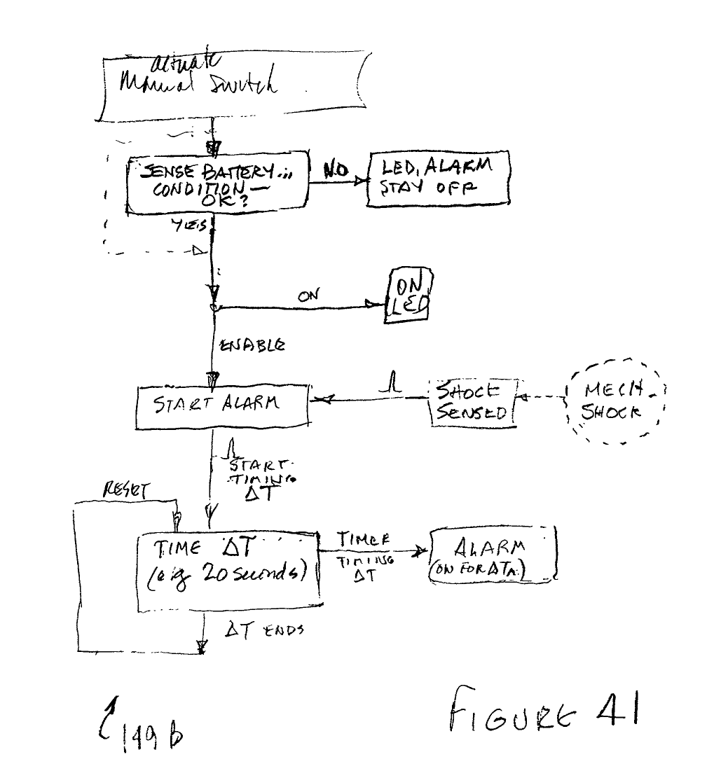

The circumferentially spaced, axially extending grooves 84 in the interior peripheral wall of the yoke recess 83 resiliently alternately receive the radially outward, axially extending protrusion 94 on the adapter 88 to maintain the yoke 80 in one of several selected circumferential positions on the adapter 88 and hence on the upper end portion of the tube 70. Thus, the yoke 80 may lie substantially parallel to the hinge axis of the device 10, or may be positioned at about 90° in either direction therefrom. The yoke 80 is firmly resiliently fixed on the adapter 88 and tube 70, but by application of a sufficient manual axial force it can be removed therefrom and replaced thereon at an alternative circumferential position. For example, in FIG. 39, the device 10 is adapted to secure a closed sliding window or patio door PD with the yoke 80 engaging the handle H of the door and circumferentially located on the adapter 88 at about 90° from its orientation of FIG. 3. In FIG. 9, the device 10 may parallel the face of the patio door PD, or may be somewhat angled therefrom, so that its foot 20 lies somewhat further from the patio door PD than the yoke 80, without hampering securing of the door by the device 10.

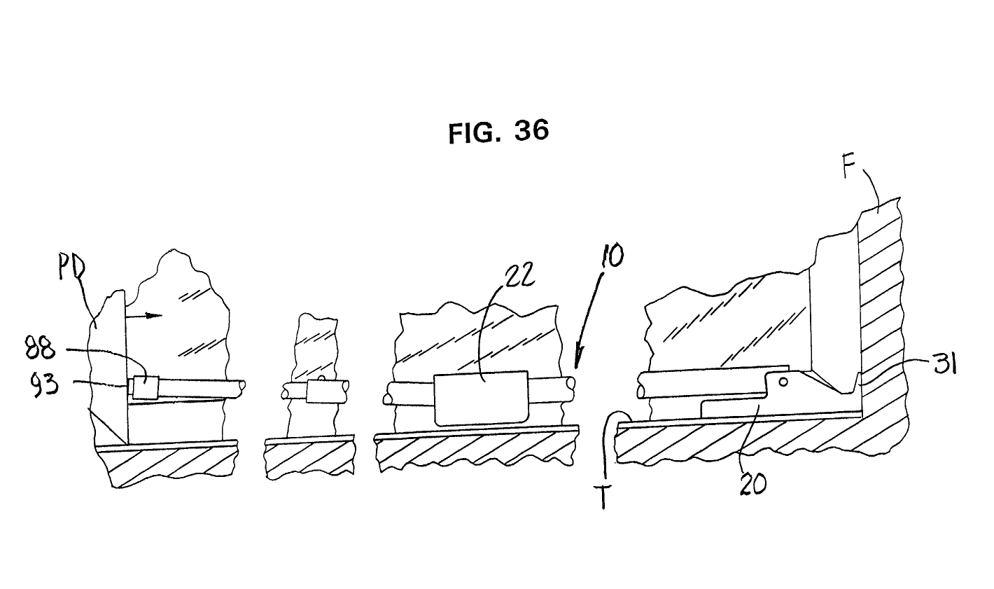

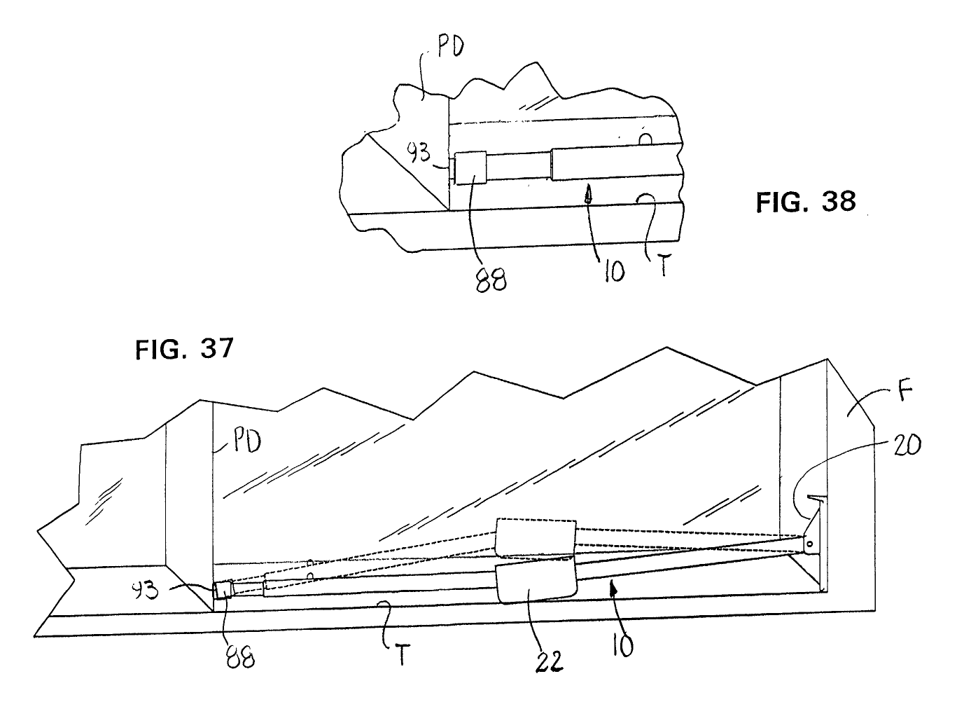

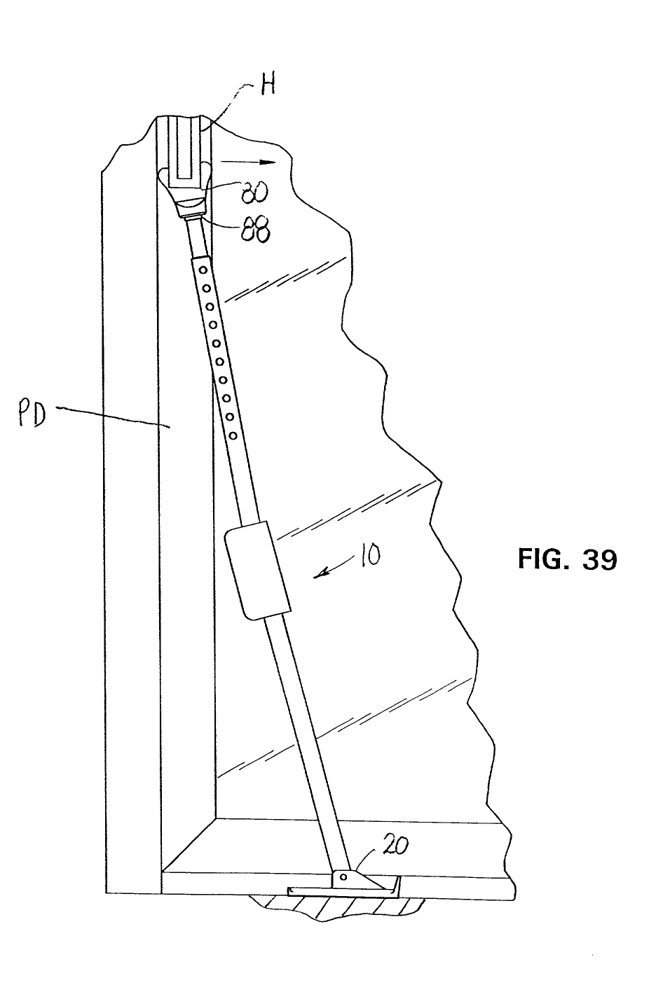

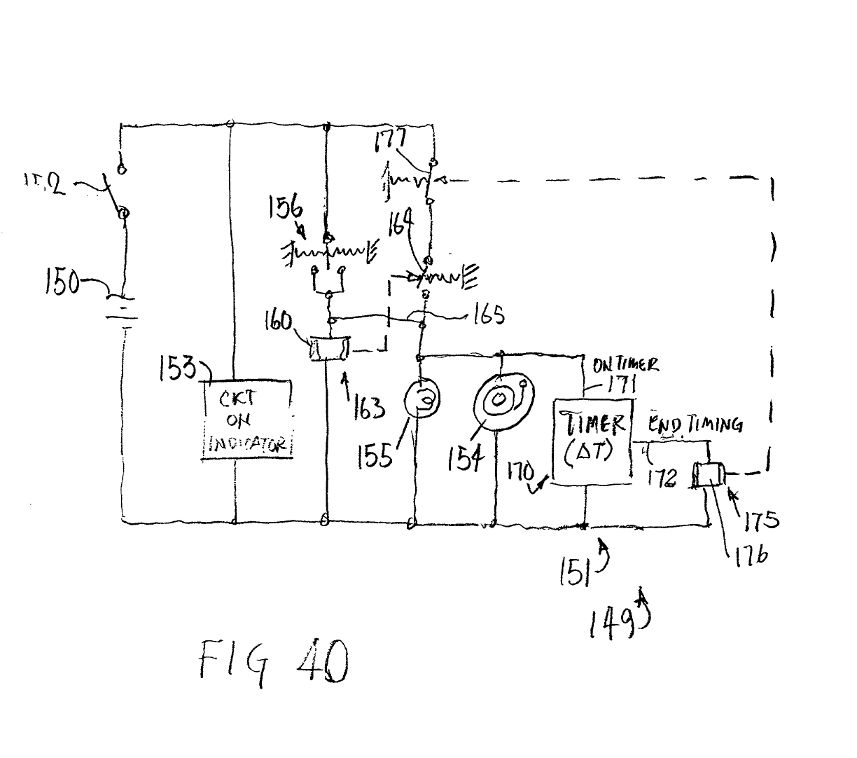

Alternately, the yoke 80 can be removed from the adapter 88 and tube 70, leaving the traction face 93 of the traction flange 92 exposed. In this mode, as seen in FIGS. 37 and 38, the device 10 can be located along and, closely adjacent to the guide track T of a sliding window patio door PD, and aligned between the edge of the closed patio door PD. With the traction face 93 abutting one of the patio door PD and frame F (here the former) and the sole of the shoe 20 abutting the other, as indicated in FIG. 37, pushing the handle 22 toward the track T sets the device 10 in its above described over-center, door locking position. Thus, as above described with respect to the swinging door of FIGS. 1-3, an unauthorized attempt to open the sliding door PD by an intruder will mechanically shock, or jiggle, the device 10, which then alarms and thus warns the occupant of the room, while at the same time positively blocking opening movement of the patio door PD rightward from its closed position shown.

Whereas in FIG. 7 the sole of the shoe 20 provides a good friction grip against the upstanding door frame F, it may be desired to secure sliding window or patio door PD, wherein the spacing between the closed patio door PD and door frame F exceeds the maximum useable length of the device 10 with the foot 20 in its FIG. 37 position, substantially perpendicular to the length dimension of the device 10. In that instance, as seen in FIG. 36, it is possible to somewhat further extend the effective length of the device 10 by rotating the foot 20 through about 90° (clockwise from its FIG. 37 position to its position shown in FIG. 36) wherein the sole of the foot extends along the door track T and the toes 31 of the foot 20 abut the door frame F. In this way, the device 10 can adapt to an unusually long sliding closure (patio door or window) track T without need to increase the length of the device 10 in its stored FIG. 1 position.

Although a particular preferred embodiment of the invention has been disclosed in detail for illustrative purposes, it will be recognized that variations or modifications of the disclosed apparatus, including the rearrangement of parts, lie within the scope of the present invention.

What is claimed is:

1. An anti-intrusion apparatus for a portal closure, comprising:
a first leg unit having an outer end portion engagable with a closed movable closure at a portal;
a second leg unit having an outer end portion engagable with fixed portal-adjacent structure;
a knee unit pivotally joining adjacent inner end portions of said leg units, said leg units having:
(1) a compact, folded, storage position in which said leg units are closely adjacent and substantially parallel to each other,
(2) a fully unfolded use position in which said leg units extend generally away from each other in a nonaligned manner, and
(3) intermediate positions spaced along an arc between said storage and use positions, said storage and use positions defining the ends of said arc, said arc exceeding 180° such that said use position is in an over-center position of said leg units;
whereby with said apparatus located in said use position between a fixed portal-adjacent structure and a corresponding closed movable closure, for holding the latter closed, an increasing axial compressive force applied to the apparatus, adjacent said portal-adjacent structure end portion and closed movable closure engagable end portion of said leg units, increases the force holding the apparatus in said use position and the ability of the apparatus to hold a movable closure securely closed.

2. The apparatus of claim 1 in which said knee unit includes first and second hinge parts, each said hinge part including a boss having a longitudinal central axis and a flange extending axially from said boss, said flange having a radially extending ear, said flange ears overlapping and being pivotably connected on an axis radially offset from said central axes of said bosses, at least one hinge part flange having an end surface, the other hinge part boss having an end surface, at least one said end surface being in a plane at an acute angle to its boss central axis, said flange and boss end surfaces abutting at said over-center position of said leg units.

3. The apparatus of claim 1 in which said knee unit comprises first and second hinge parts having pivotally connected portions, said first and second hinge parts having respective bosses extending from said pivotally connected portions, said first and second leg unit inner end portions being tubular and telescoped on respective ones of said bosses and fixed thereto.

4. The apparatus of claim 3 in which a given said boss has a generally radially outwardly opening blind hole, a fastener on said telescoped tubular end portion fixedly gripping an interior surface of said blind hole and thereby fixing the corresponding said leg unit on said boss.

5. The apparatus of claim 4 in which said fastener is a pop rivet.

6. The apparatus of claim 1 in which said knee unit includes a generally saddle shaped handle having a longitudinal groove, said pivotally joined leg unit end portions being housed in said groove, one said leg unit inner end portion being fixed to said handle and the other said leg unit inner end portion being pivotable with respect to said handle.

7. The apparatus of claim 6 in which said handle has side walls spaced by said groove, a detent projection on at least one of said side walls and projecting into said groove in resilient interfering relation with said other leg unit inner end portion at said intermediate position, and therewith resilient fixing said leg units in said intermediate position.

8. The apparatus of claim 6 in which said handle has side walls spaced by said groove, a detent projection on at least one of said side walls and projecting into said groove in resilient interfering relation with said other leg unit inner end portion at said folded storage position and therewith resiliently fixing said leg units in said storage position.

9. The apparatus of claim 1 in which one said leg unit outer end portion carries a foot pivoted thereon through at least 90° of pivotal motion and having a frictionally gripping surface to fixedly engage a fixed portal adjacent structure.

10. The apparatus of claim 1 in which one said leg unit outer end portion carries a foot pivotally thereon for pivoting through at least a 90° angle, said foot having upstanding toes laterally spaced to snugly straddle said one leg outer leg portion, a detent projection on at least one said toe resiliently engaging said one leg outer end portion and thereby resiliently fixing said foot substantially parallel to said one leg in said folded storage position.

11. The apparatus of claim 1 in which said one leg unit outer end portion carries a resilient frictionally gripping end surface engagable in axially pressed relation against one of a closure and a fixed portal-adjacent structure to keep a portal closed by a corresponding closure.

12. The apparatus of claim 1 including a yoke having an end recess, said end recess snugly removably receiving the outer end portion of one said leg unit, one of said one leg unit outer end portion and yoke end recess carrying an axial rib, the other of said one leg unit outer end portion and yoke end recess having circumferentially spaced, axially endwardly opening grooves sized to receive said rib, said yoke having alternate circumferentially spaced locations on said one leg unit outer end portion determined by engagement of said rib in respective alternate ones of said grooves.

13. The apparatus of claim 1 in which said knee unit has a generally saddle shaped handle having a longitudinal groove, said leg unit inner end portions being housed in said groove, one said leg unit being fixed in said groove, the other said leg unit being pivotable in said groove, said groove defining an interior surface of a bight wall of said handle, said groove being recessed adjacent one end by an angled ramp extending through one end of said handle such that said interior surface of said bight wall defines an angle of greater than 180° and thereby permits pivoting of said leg units from said intermediate position to said fully unfolded, over-center, use position.

14. The apparatus of claim 1 in which one of said leg units comprises adjustably axially telescoping inner and outer tubes, said inner and outer tubes having releasably engagable interlocking structure actuable to change said one leg unit from one fixed length to another.

15. An anti-intrusion apparatus for a portal closure, comprising:
a first leg unit having an outer end portion engagable with a closed movable closure at a portal;
a second leg unit having an outer end portion engagable with fixed portal-adjacent structure;
a knee unit pivotally joining adjacent inner end portions of said leg units, said leg units having:
(1) a compact, folded, storage position in which said leg units are closely adjacent and substantially parallel to each other,
(2) a fully unfolded use position in which said leg units extend generally away from each other in a non aligned manner,
(3) an intermediate, somewhat flexed installation position located between said storage and use positions and in which said leg units are pivoted away from said storage position less than 180°;
detent structure between said knee unit and at least one of said leg units, said one leg unit being pivotally fixed with respect to said knee unit, said one leg unit and knee unit interengaging through and being resiliently interfixed by said detent structure in one said position;
whereby, in said one position, the apparatus is of a stable shape, free of unwanted folding and unfolding flexure.

16. The apparatus of claim 15 in which said knee unit includes a generally channel shaped handle having a bight wall joining spaced side walls, said one leg unit extending into said handle, said detent structure being disposed between at least one of said handle side walls and said one leg unit.

17. The apparatus of claim 16 in which said detent structure comprises a projection on an inboard surface of said one handle side wall and located in a pivot path of said one leg unit with respect to said handle side walls, said projection being interposed between said folded and intermediate positions of said one leg unit and resiliently fixing said one leg unit against movement between said folded and intermediate positions.

18. The apparatus of claim 15 in which said detent structure comprises a projection on an inboard surface of said one handle side wall and located in a pivot path of said one leg unit with respect to said handle side walls, said projection being interposed between said intermediate and over-center positions and resiliently fixing said one leg unit in said intermediate position.

19. An anti-intrusion apparatus for a portal closure, comprising:
a first leg unit having an outer end portion engagable with a closed movable closure at a portal;
a second leg unit having an outer end portion engagable with fixed portal-adjacent structure;
a knee unit pivotally joining adjacent inner end portions of said leg units, said knee unit having:
(a) a generally channel shaped handle having a bight wall joining spaced side walls,
(b) a hinge structure within said handle and pivotally connecting adjacent end portions of said leg units, and
(c) an alarm unit in said knee unit handle.

20. The apparatus of claim 19 in which said alarm unit is mechanically shock sensitive, said alarm unit including a sensor responsive to mechanical disturbance, a power source and an alarm output device carried in said knee unit handle and operatively associated to output an alarm in response to an unauthorized attempt to disturb a closed portal closure guarded by the apparatus.

21. The apparatus of claim 20 in which said sensor, source and alarm output device are fixedly located in said side walls.

22. The apparatus of claim 20 in which said alarm unit comprises a switch manually actuable to arm said alarm unit.

23. The apparatus of claim 20 in which said alarm unit has a timer operative interposed between said sensor and alarm output device whereby momentary disturbance of said sensor energizes said alarm output device for a preselected time interval.

24. The apparatus of claim 23 including structure operatively interposed between an output terminal of said timer and said alarm output device and sensor, and responsive to timing out of said timer for shutting off said alarm output device and resetting said alarm unit for another unauthorized attempt to disturb a closed portal closure guarded by the apparatus.

25. The apparatus of claim 20 which said apparatus has (1) a flexed position with said leg units at less than a 180° angle to each other and (2) an over-center use position with said leg units at a greater than 180° angle with respect to each other, said handle unit having a hand pushable surface oriented to push said apparatus from said flexed position to said over-center use position.

26. The apparatus of claim 25 in which said alarm unit comprises a switch adjacent said push surface and having an actuated position which connects said power source to the remainder of said alarm unit.

27. The apparatus of claim 20 in which said generally channel shaped handle comprises a narrow, generally channel shaped backbone of a tough durable material and having spaced sides generally mirrored imaged, hollow shells fixed to and laterally flanking said sides of said backbone and defining therewith hollow portions housing said alarm unit.

28. The apparatus of claim 20 in which said handle is of rigid molded material, parts of said alarm unit being embedded in said material.
